(19) United States
(12) Patent Application Publication
(10) Pub. No.: US 2006/0252359 A1
(43) Pub. Date: Nov. 9, 2006

(54) Deer evisceration apparatus

(76) Inventor: Orlin H. Helbing, Janesville, WI (US)

Correspondence Address: RYAN KROMHOLZ & MANION, S.C., POST OFFICE BOX 26618, MILWAUKEE, WI, 53226, US

(21) Appl. No.: 11/124,945

(22) Filed: May 9, 2005

(51) Int. Cl. A22C 25/06

(52) U.S. Cl. 452/194

(57) ABSTRACT

A portable apparatus for eviscerating an animal comprising a base arranged for placement on a flat surface, a first upright section, and a second upright section. The base supports the upright sections in a spaced apart manner, sufficient enough to form a cross-sectional area defined by the base and upright sections to receive the animal in a lengthwise prone position.

### BACKGROUND OF THE INVENTION

The present invention relates to devices and processes for field dressing deer and related animals. When hunting deer or other big game, it is advantageous to dress the animal before you leave the woods or hunting area and also to dress the deer rather quickly after killing the deer.

Generally, there are two basic ways to situate the animal when dressing the animal: hoist the animal from a tree or other upright structure, or lay the animal on its back. Hoisting a deer may be a cumbersome undertaking, especially if the deer is of substantial size. Furthermore, you may be in an open field or other area where there are no trees around.

The other option is to lay the animal on its back. However, to properly field dress or eviscerate an animal, the animal needs to be stationary, which normally requires either propping the animal up against a tree or other structure, or to have a second person hold the animal stationary. As previously stated, there may be no trees in the area where you are dressing the animal and, also, there may be no one close around to hold the deer while you are dressing the deer.

### SUMMARY OF THE INVENTION

The present invention is a portable apparatus for eviscerating an animal, especially when hunting and out in the field. The apparatus comprises a base that can be placed on the ground or other relatively flat surface. The base supports two upright sections in a spaced apart fashion. The base and the upright sections form a cross-sectional area, which is sufficient to receive the animal in a lengthwise prone position. Connecting means may be used to connect the upright sections and further contain the animal in the cross-sectional area. Thus, an animal, such as a deer or other game, may be laid on its back and eviscerated easily and efficiently by an individual person.

### BRIEF DESCRIPTION OF THE DRAWINGS

FIG. 1 shows a perspective view of an eviscerating apparatus according to the present invention.

FIG. 2 is a perspective view of the apparatus of FIG. 1 further retaining a deer.

FIG. 3 is an exploded view of the apparatus of FIG. 2.

FIG. 4 is a close-up sectional view of the apparatus of FIG. 2.

FIG. 5 is a front planar view of the apparatus of FIG. 1 depicting different cross-sectional retaining areas for the apparatus.

FIG. 6 is a perspective view of the apparatus of FIG. 1 in a partially compact position.

FIG. 7 is a perspective view of the apparatus of FIG. 1 in a compact position.

FIG. 8 is a perspective view of the apparatus of FIG. 1 being transported.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

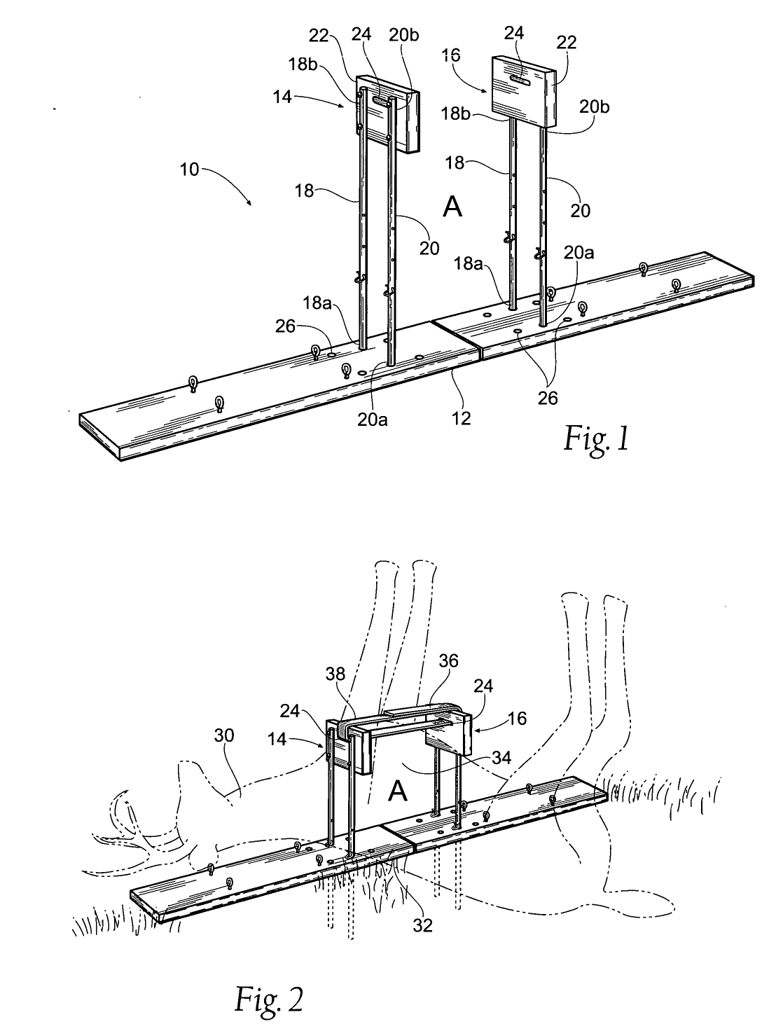

FIG. 1 shows a perspective view of an animal eviscerating apparatus 10. The apparatus 10 comprises a base 12, a first upright section 14 and a second upright section 16. The upright sections 14, 16 preferably are designed alike, and like parts will be referred to with like reference numerals. For clarity, unless indicated, reference to the upright section 14 or 16 will also refer to the other upright section, including the specific elements or components of the upright sections. The upright sections 14, 16 comprise a first rod 18 and a second rod 20. The rods 18 and 20 have a first end 18a and 20a, and a second end 18b and 20b, respectively. The first ends 18a and 20a are proximal to the base 12 and the second ends 18b and 20b are connected to a gripping section 22. The gripping section 22 has a through passageway 24 and acts as a handle for grabbing the upright sections 14, 16 and to assist in removing and connecting the upright sections 14, 16 to the base 12. The rods 18 and 20 preferably are spaced apart sufficiently enough from each other across the width of the base so that the upright sections 14, 16 are sufficiently balanced when connected to the base 12. The intersection of the base 12 and the uprights sections 14, 16 define a cross-sectional area A, which provides an area for an animal (see FIG. 2) to be retained.

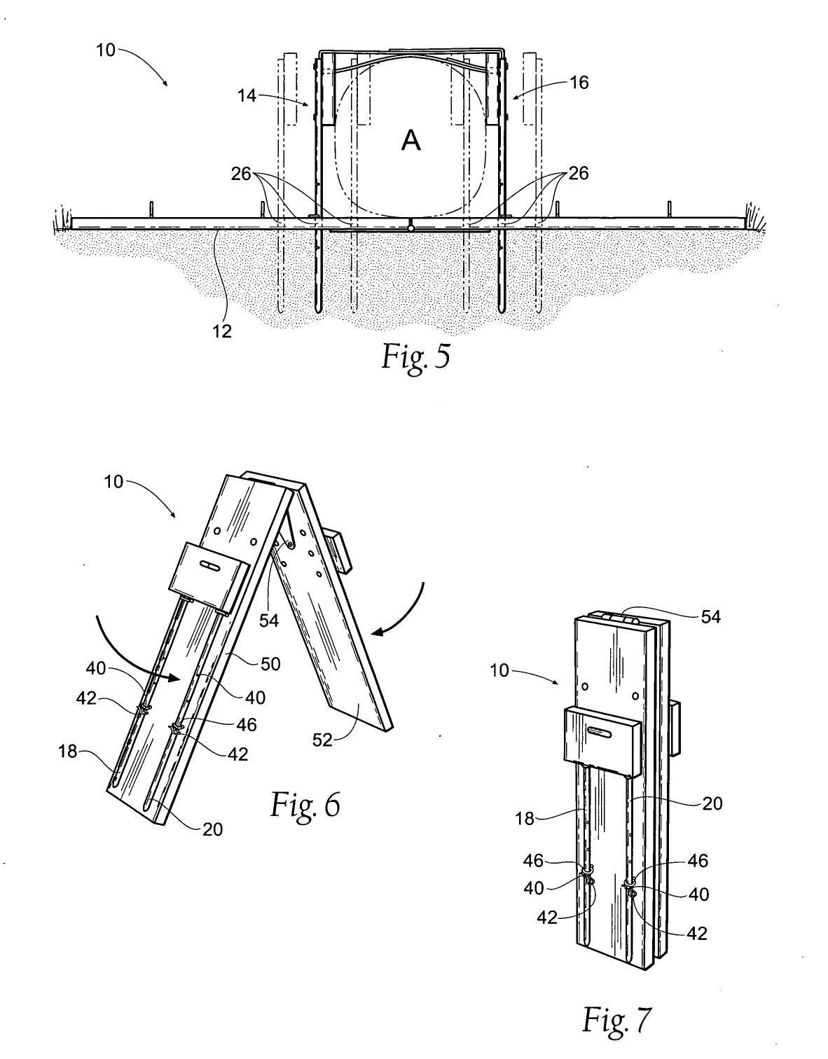

Still referring to FIG. 1, the upright sections 14, 16 are connected to the base 12 by support means or holes 26. The holes 26 allow the rods 18, 20 to be inserted into the base 12 and connected to the base 12. The support means 26 may take any form that will allow the upright sections to be connected and supported by the base 12. For instance, the support means 26 could comprise a plug-style structure, a clamp that would connect the upright sections 14, 16 to the base, or a hinge or pivot or any other device that will allow the upright sections 14, 16 to be locked in an upright section with respect to the base 12. As shown, there is a plurality of holes 26 located on the base 12, which allows the apparatus 10 to be adjusted for a plurality of predetermined cross-sectional areas A (see FIG. 5), thereby accommodating animals of varying sizes.

Referring to FIG. 2, the apparatus 10 is shown restraining a deer 30 (shown in phantom). The deer 30 rests within the cross-sectional area A on its back 32 in a prone position, preferably with the base 12 centered about the torso 34 of the deer 30. A strap 36 acts as connection means for joining the first upright section 14 with the second upright section 16 and, further restrains the deer 30 for the evisceration process. The strap 36 further defines the cross-sectional area A. The strap 36 passes through the passageways 24 and can be fastened to itself with fastening means 38 such as a hook and loop material, such as Velcro®, or other fastening means including, but not limited to, snaps, buckles, or other fastening devices. While it is preferable to have the strap 36 be a removable element of the apparatus 10, it is understood that the strap 36 could be in the form of other connection means and still fall within the scope of the invention, such as a pivotal arm that is connected to one of the upright sections 14, 16. Any structure that will join the first upright section 14 and the second upright section 16 to further define the cross-sectional area A and provide a structure for restraining the deer 30 during the evisceration process should be understood as being within the scope of the present invention.

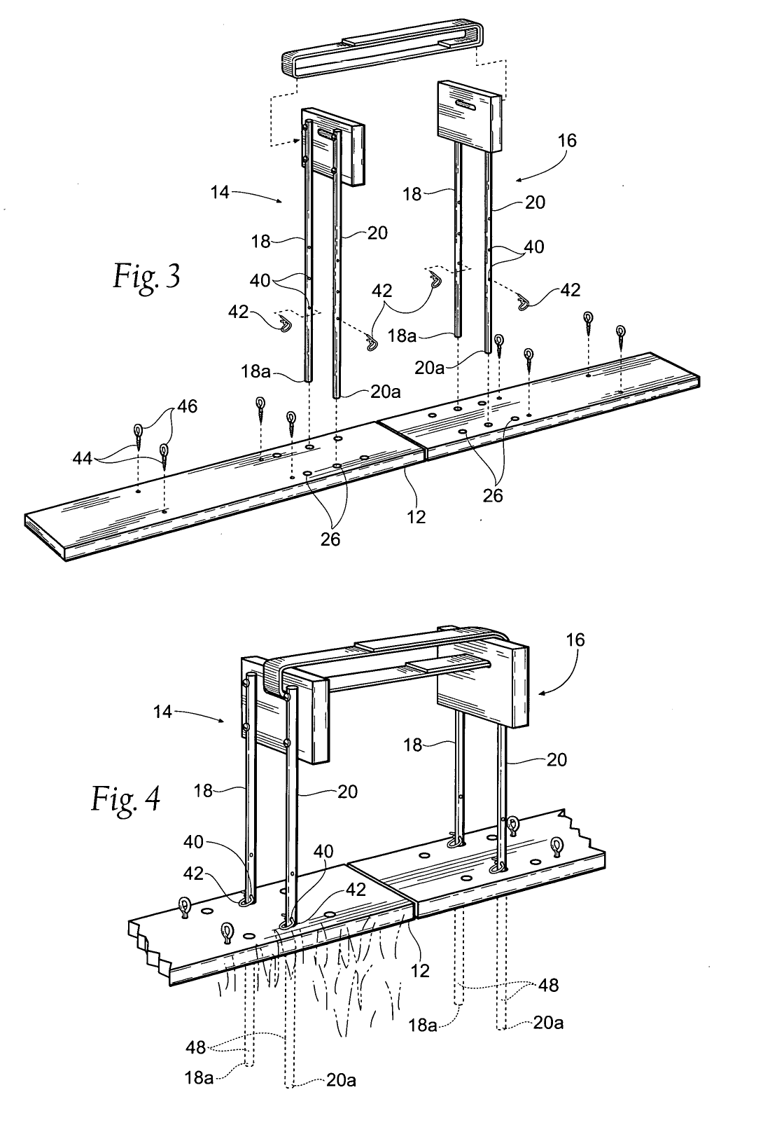

FIG. 3 shows an exploded view of the apparatus 10. As previously discussed, the upright sections 14, 16 are supported by the base 12 by inserting the first ends 18a and 20a of the rods 18 and 20 into the holes 26. The holes 26 preferably extend completely through the base 12, thereby allowing the ends 18a and 20a of the rods 18 and 20 to pass completely through the base 12, as well (see FIGS. 4 and 5). As will be shown in FIGS. 4 and 5, this is advantageous in further securing the apparatus 10 to the ground or other surface that the apparatus 10 is placed upon. The upright sections 14, 16 preferably intersect the base 12 perpendicular to the base 12, which will provide the necessary support for holding the deer 30 in a prone position without putting undue pressure on the upright sections 14, 16.

Still referring to FIG. 3, a plurality of pin holes 40 are located on the rods 18, 20. A pin, such as cotter pin, 42 releasably intersects the pin holes 40. The pins 42 and the pin holes 40 allow adjustment of the height of the upright sections 14, 16 when they are inserted into the base 12. The pin holes 40 preferably are parallel and aligned on the rod 18 relatively with corresponding pin holes 40 on the rod 20, which assists in properly securing the upright sections 14, 16 when they are inserted into the base 12. Likewise, the pin holes 40 on the upright sections 14, 16 are also preferably horizontally aligned with one another.

FIG. 3 also shows a plurality of screws 44 each having an eyelet 46. The screws 44 are attached to the base 12 and act as retention means when the upright sections 14, 16 are to be stored. As will be shown further with respect to FIGS. 6 and 7, the rods 18, 20 are inserted through the eyelets 46 for storage or transportation purposes when the apparatus 10 is not in use. The screws 44 are arranged preferably with at least two screws 44 in series, with each series corresponding to one of the rods 18, 20 (see FIGS. 6 and 7). As will be evident further with respect to FIGS. 6 and 6, when the rods 18, 20 are slid through the eyelets 46, the pins 42 inserted into the pin holes 40 may further act as a locking mechanism to retain the upright sections 14, 16. For instance, when the rods 18, 20 are inserted into the screws 44, the pins 42 could reside in pin holes 40 in a manner to restrict the sliding movement of the rods 18, 20. It is also understood that other devices, such as clamps, pins, snap fittings, or other retaining devices may replace the screws 44 and still fall within the scope of the present invention.

FIG. 4 provides a close-up view of the upright sections 14, 16 intersecting the base 12. As previously noted, the base 12 rests upon a relatively horizontal surface. Because the apparatus 10 is designed for outdoor use, the surface is probably earth, dirt, or a similar surface. As the rods 18, 20 are inserted through the holes 26, the ends 18a, 20a come in contact with the surface. When the rods 18, 20 are further inserted through the holes 26, the rods 18, 20 penetrate the surface, thereby providing securing means 48 for securing the apparatus 10 to the surface. Inserting the pins 42 into the holes 40 into a specific hole will determine how far the rods 18, 20 can be inserted into the ground or surface. The ends 18a, 20a preferably have a conical, pointed or spiked shape, which assists the rods 18, 20 in penetrating the ground when the ground may be frozen or very dense. By securing the apparatus 10 to the surface, it will make the evisceration process easier by holding the apparatus 10 in place. As shown in FIG. 4, the securing means 48 are integral extensions of the rods 18, 20 of the upright sections 14, 16. However, it is understood that the securing means 48 shown in FIG. 4 is merely exemplary and the securing means 48 may be designed in other manners. For instance, the securing means may be a separate structure attached to other areas of the apparatus. Provided the structure will assist in securing the apparatus 10 to a surface, the structure would be understood to be securing means as disclosed in the present invention.

FIG. 5 shows the apparatus 10 with the upright sections 14, 16 inserted to the base 12 into the holes 26 at varying spatial orientations, which will provide varying cross-sectional areas A to accommodate animal of varying sizes. The holes 26 are preferably evenly spaced apart from the center of the base 12, to thereby provide further balance for the apparatus 10 when eviscerating an animal. The apparatus may have more or fewer spatial orientations than shown in FIG. 5.

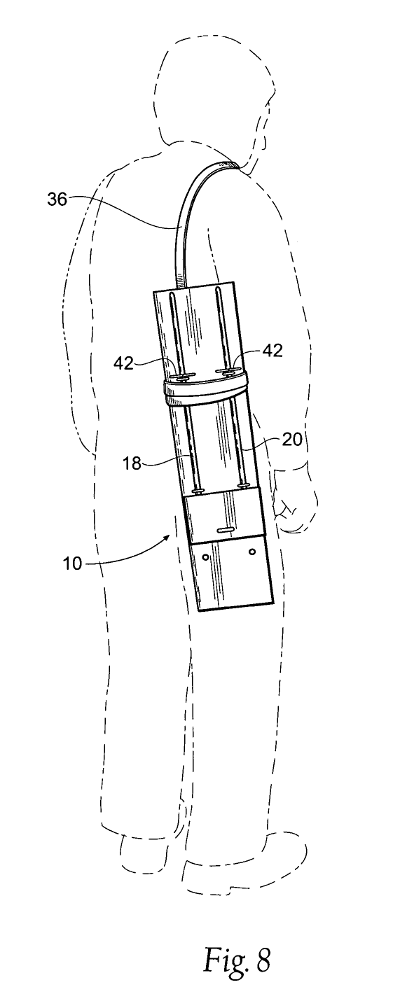

FIGS. 6, 7, and 8 depict the portability of the apparatus 10. The apparatus 10 has a first base section 50 and a second base section 52. A hinge 54 pivotally connects the sections 50, 52. The hinge 54 allows the apparatus 10 to be folded in half, which makes the apparatus easier to transport. Preferably, the base sections 50, 52 are of the same relative size, with the hinge 54 centrally located between the sections 50, 52. The upright sections 14, 16 are secured to the base sections 50, 52, respectively by sliding the rods 18, 20 through the eyelets 46. The support holes 26 are preferably evenly divided and arranged on each of the base sections 50, 52, thereby allowing each of the upright sections 14, 16 to be supported on an individual base section 50 or 52. The pins 42 interacting with the pin holes 40 further secure the upright sections 14, 16 to the base sections 50, 52, which prevent the upright sections 14, 16 from sliding off of the base sections 50, 52 during transportation of the apparatus 10. As shown in FIG. 8, the strap 36 can also be arranged as a sling so that the apparatus 10 may be easily carried around a person's shoulder.

The present invention provides a simple, portable device that allows a single individual to eviscerate or field dress a wild game without hoists or the like. The design is preferably made of lightweight, sturdy material, such as wood, aluminum, or plastic material, that will fully support and retain an animal, while being light enough for an individual user to carry.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A portable apparatus for eviscerating an animal, said apparatus comprising:
a base being arranged for placement on a relatively horizontal surface;
a first upright section;
a second upright section;
means for supporting said first and said second upright sections, said supporting means located on said base;
said first and said second upright sections being spaced apart when supported by said base; and
a cross-sectional area defined by said base and said upright sections, said cross-sectional area being sufficient to receive said animal in a lengthwise prone position.

2. The apparatus according to claim 1 wherein said upright sections are removably supported by said base.

3. The apparatus according to claim 2 further comprising a plurality of means for supporting said first and said second upright sections, said plurality of supporting means providing a plurality of cross-sectional areas defined by said base section and said upright sections.

4. The apparatus according to claim 1 wherein said base further comprises a first base section and a second base section, said first and said second section pivotally connected to one another.

5. The apparatus according to claim 4 wherein said first upright section is supported by said first base section and said second upright section is supported by said second base section.

6. The apparatus according to claim 1 further comprising means for connecting said first upright section to said second upright section, said connecting means further defining said cross-sectional area.

7. The apparatus according to claim 6 wherein said connecting means are removable.

8. The apparatus according to claim 7 wherein said connecting means further comprise means for transporting said apparatus.

9. The apparatus according to claim 1 further comprise means for adjusting the height of said upright sections.

10. The apparatus according to claim 1 further comprising means for removably securing said apparatus to said horizontal surface.

11. The apparatus according to claim 10 wherein said securing means are integral with said first and said second upright sections.

12. A portable apparatus for eviscerating an animal on a relatively horizontal surface, said apparatus comprising:
a base being arranged for placement on said relatively horizontal surface;
means connected to said base for supporting said animal in a prone position on said base; and
means for retaining said animal to said base.

13. The apparatus according to claim 12 wherein said support means are removably secured to said base.

14. The apparatus according to claim 13 wherein said support means are adjustably spaced on said base.

15. The apparatus according to claim 12 wherein said apparatus further comprises means for removably securing said apparatus to said relatively horizontal surface.

16. A portable apparatus for eviscerating an animal on a relatively horizontal surface, said apparatus comprising:
a base being arranged for placement on said relatively horizontal surface;
a first upright section being removably connected to said base;
a second upright section being removably connected to said base;
a cross-sectional area defined by said base and said first and said second upright sections when said first and said upright sections are connected to said base; and
means for removably securing said base to said relatively horizontal surface.

17. The apparatus according to claim 16 further comprising a strap removably connected to said first and said second upright sections, said strap providing means for retaining said animal in a prone position within said cross-sectional area.

18. The apparatus according to claim 17 wherein said cross-sectional area is adjustable.

19. The apparatus according to claim 17 wherein said strap further comprises means for transporting said apparatus.

20. The apparatus according to claim 19 further comprising means storing said first and said second upright sections on said base when transporting said base.
